(19) United States
(12) Patent Application Publication
(10) Pub. No.: US 2008/0312773 A1
(43) Pub. Date: Dec. 18, 2008

(54) Barrier-Free Appliance

(75) Inventor: Bijon Nag, Karnataka (IN)

Correspondence Address: BIRCH STEWART KOLASCH & BIRCH, PO BOX 747, FALLS CHURCH, VA, 22040-0747, US

(73) Assignee: IFB Industries Limited, Mahadevapura (IN)

(21) Appl. No.: 11/792,862

(22) PCT Filed: Dec. 13, 2005
(86) PCT No.: PCT/IN2005/000412

§ 371 Date: Jan. 11, 2008

(30) Foreign Application Priority Data
Dec. 13, 2004 (IN) 1355/CHE/2004

(51) Int. Cl. G05B 15/02; D06F 33/02; B08B 3/04; F26B 3/02

(52) U.S. Cl. 700/275; 68/12.01; 134/58 D; 34/487

(57) ABSTRACT

The present invention provides a method for barrier-free control of a household appliance, said method comprising, providing a program-controlled household appliance with a control panel having a plurality of operating program selectors for selecting programs of appliance operations and corresponding program cycles controlled by a micro controller, a memory component for storing the functions of the appliance operating programs and corresponding program cycles, a display unit for displaying the output of the status of the appliance operation, selecting the desired appliance operating program, enabling by an automatic selection a set of compatible program cycles corresponding to the selected appliance operating program, disabling automatically the corresponding non-compatible program cycles that are contrary to the selected appliance operating program, disabling automatically the corresponding non-compatible program cycles that are contrary to the selected program cycles, and executing the program cycles of the selected appliance operating program.

### TECHNICAL FIELD

The present invention relates to a system and a method for barrier-free control of an appliance by indicatively enabling a user to perform compatible appliance operating programs along with compatible program cycles and disabling the user from performing the non-compatible program cycles corresponding to the enabled set of appliance operating programs.

### BACKGROUND AND PRIOR ART

Household appliances such as Washing machines, Dishwashers, Laundry dryers etc., are used to wash and clean fabrics and dishes both domestically and commercially. The options that are made available to the users of these appliances, in selection and execution of tasks associated with washing and cleaning of the selected articles, have grown exponentially over a period of time.

Considering the complexities that are associated with the selection and execution of these tasks, a higher demand is placed on user's familiarity with the functioning of a household appliance.

For instance, considering the functioning of washing machines, which are one of the widely used household appliances, are equipped to wash clothing material of different types. The clothing material may be cotton, different polyester materials, silk cloth, etc. The type of the cloth determines the type of the washing module/program to be used. The washing modules/programs comprise necessary functionalities to execute corresponding working operations of a washing cycle. Accordingly, in a washing machine, there is a plurality of main functional modules available to a user. Some of the main functional modules/programs that are available to a user include:
Cottons Module—This module is used to execute functions for washing cotton fabrics at various temperature levels ranging from cold to very high temperatures (95° C.). The cotton fabrics include cottons (White and Coloured), soiled cottons, bed sheets, curtains, under garments, towels, shirts, trousers etc.
Synthetics Module—This module is exercised for washing synthetic fabrics at various temperature levels ranging from cold to high temperatures (60° C.). This module is executed especially for washing easy care fabrics made from cotton, synthetics, lightly soiled blouses and shirts etc made of polyester or similar blends.
Eco Module—This module is exercised for washing heavily soiled cotton/synthetic clothes such as whites, cottons and coloreds, bed sheets, curtains, towels, shirts and trousers at selected temperature levels.
Delicates Module—This module is utilized for washing sensitive easy care fabrics like skirts, blouses, and shirts, net curtains, mixed fibre fabrics or Turkish towels at a lower temperature.
Woolens Module—This module is utilized for washing hand-washable or machine-washable fabrics made from wool or wool blend.
Silk Module—This module is used to wash silk fabrics.
Mini Module—This module is used for cleaning very lightly soiled daily wear garments.
Drain Module—This program is used for draining out the water from the washing machine.
Rinse and Spin Module—It includes exclusive rinse cycles with subsequent spin cycle. This program is suitable for rinsing hand-washed items.
Spin Module—This is an exclusive spinning program. This module is useful for squeezing out water from hand washed/rinsed items.

In addition to these main functional modules, there are optional program cycles that are available to a user. These program cycles also contain functional features for performing various washing tasks. The optional program cycles include pre-washing program cycle, soaking program cycle, quick washing program cycle, intensive washing program cycle, water plus program cycle, additional rinse program cycle, rinse-hold program cycle and time-delay program cycle.

In a known way, a user of a washing machine needs to be familiar with various options with regard to functional modules to understand the applicable, non-applicable and the contradictory program cycles for all the main-modules. This is due to the fact that, when a particular main-module is chosen there is no indication as to availability of applicable optional program cycles. Whereas, if a user tries to select a non-applicable or contradictory optional program cycle corresponding to the main module there will not be any indication on the program cycle to indicate that it is inactive and non-available. Hence, due to lack of proper knowledge, the user may keep pressing the non-available or contradictory optional program cycle button without realizing that this program cycle is not available for the said task and may assume that the machine is malfunctioning. This is further aggravated by the fact that no proper indication is available to the user to indicate the non-availability of such a program cycle.

Therefore, it is important to prevent the selection of contradictory functions from the main and optional program cycles, since a user is not provided with a knowledge or means to distinguish program/modules that are contradicting each other and programs/modules that complement each other in a washing cycle. Such a scenario is felt, if a user selects an option of quick washing program cycle, such a user should not be permitted to concurrently select either intensive washing program cycle or additional rinse program cycle, as these program cycles contradict with the quick wash program cycle.

Moreover, the expressions used on the control panel of known washing machines are not in simple terms and the user is forced to comprehend the expressions bearing the functions.

Further, if a dishwasher is used to wash articles or utensils, parameters like wash temperature and the number of desired rinse cycles need to be controlled to achieve an optimum wash.

In a similar way, if a dryer is used to dry the articles like fabrics the parameters like air temperature and the duration of the drying period also need to be controlled in an optimized manner.

### OBJECTS OF THE INVENTION

Therefore, the primary object of the present invention is to provide a method for barrier-free control of an appliance that obviates the above-stated limitations.

Another object of the present invention is to provide a method for barrier-free appliance to facilitate an effective wash, cleaning and drying effects due to the implementation of appliance operation programs in conjunction with corresponding program cycles.

Another object of the present invention is to provide a method for barrier-free control of an appliance by conveniently indicating the availability of different washing, cleaning and drying operations/functions to a user.

Yet another object of the present invention is to provide a method for barrier-free control of an appliance to indicatively prevent selection of contradictory operations by a user.

### SUMMARY OF THE INVENTION

Therefore, the present invention provides a method for barrier-free control of a household appliance, said method comprising, providing a program-controlled household appliance with a control panel having a plurality of operating program selectors for selecting programs of appliance operations and corresponding program cycles controlled by a micro controller, a memory component for storing the functions of the appliance operating programs and corresponding program cycles, a display unit for displaying the output of the status of the appliance operation, selecting the desired appliance operating program, enabling by an automatic selection a set of compatible program cycles corresponding to the selected appliance operating program, disabling automatically the corresponding non-compatible program cycles that are contrary to the selected appliance operating program, disabling automatically the corresponding non-compatible program cycles that are contrary to the selected program cycles, and executing the program cycles of the selected appliance operating program.

### BRIEF DESCRIPTION OF THE DRAWINGS

FIG. 1 is a block diagram showing internal construction of a system to provide a barrier-free appliance.

FIG. 2 is a functional flow diagram for the working of the appliance in accordance with the present invention.

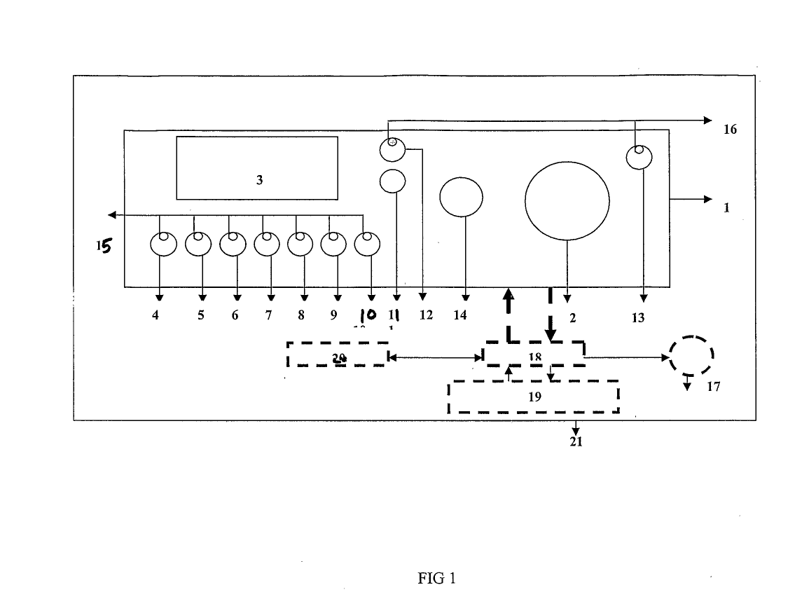

### DETAILED DESCRIPTION OF THE INVENTION

The present invention provides a method for a program-controlled household appliance with a control panel 1 having plurality of selectors 2, 4-14 for selecting appliance-operating programs and corresponding program cycles, a micro controller 19 for executing the appliance operating programs and program cycles, the household appliance having a memory component 20 for storing the functions of the appliance operations and the household appliance having a display unit 3 for displaying the output of the status of the appliance operation.

The program selector 2, is preferably a jog dial or a rotary switch, disposed to select the desired appliance-operating program. The program selector 2 can be any other suitable devices such as switch, keys etc., that can be suitably adopted.

A plurality of program cycle selectors 4-11 is disposed on the control panel 1 to indicate and enable the user to select a program cycle corresponding to the selected appliance-operating program. A switch 12 is disposed on the control panel to start/pause the operation of the appliance. A door switch 13 is provided to operate the door of the appliance. A speed selector 14 is additionally disposed, when the appliance used is a washing machine, to regulate speed of the rotation of drum.

The control panel 1 of the present invention is interfaced with the micro-controller 19 by means of an interface 18, which is generally an electronic circuit. A series of visual indicators 15 disposed on the selectors 4-10 and in turn connected to the internal electronic circuit to indicate the availability of the corresponding program cycles. A visual indicator 16 is disposed on the start/pause switch 12 to indicate the status of the running of appliance-operating program and corresponding program cycles. A visual indicator 16 disposed on the door switch 13 to indicate the status of the door closure. The visual indicators 15 & 16 used in the washing machine of the present invention are also programmed to operate in flashing mode or in continuous glow mode or in off mode.

Any selection made on the control panel 1 by the user, is communicated to the micro-controller 19 through the interface 18. In addition to interfacing the micro-controller 19 with the control panel 1, the interface unit 18 also interfaces with an audio means like a buzzer 17. The memory 20 used in the present invention is a Serial Electrically Erasable Programmable Read Only Memory (SEEPROM). However, any known programmable memory devices such as ROM, PROM and the like can also be suitably adopted.

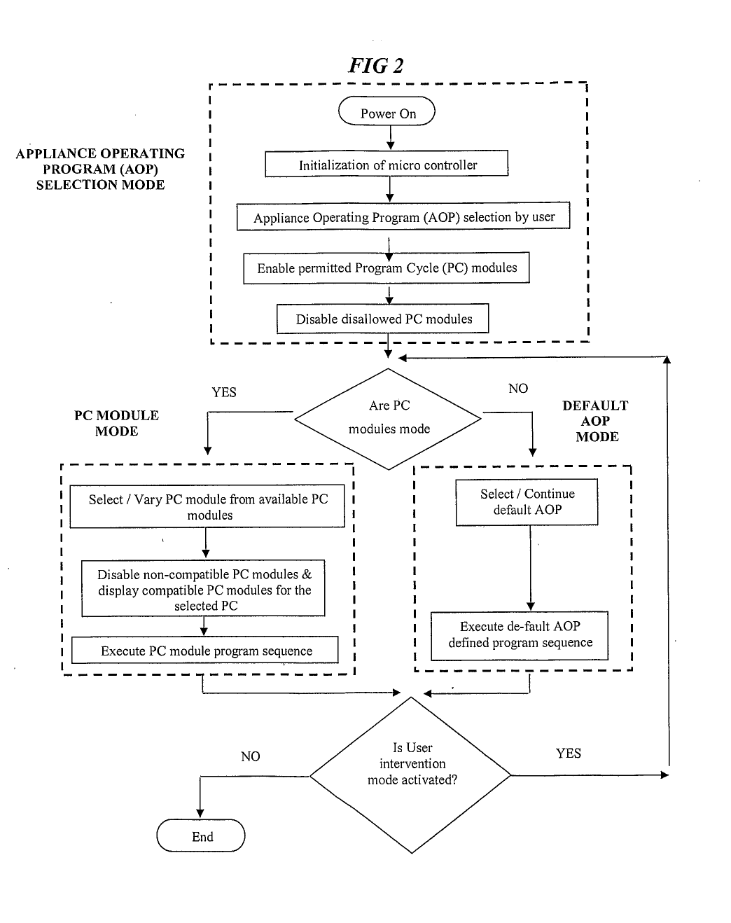

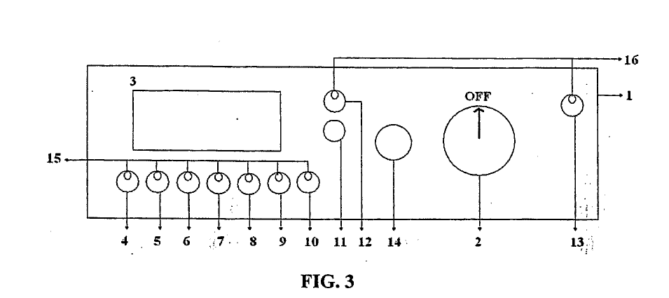

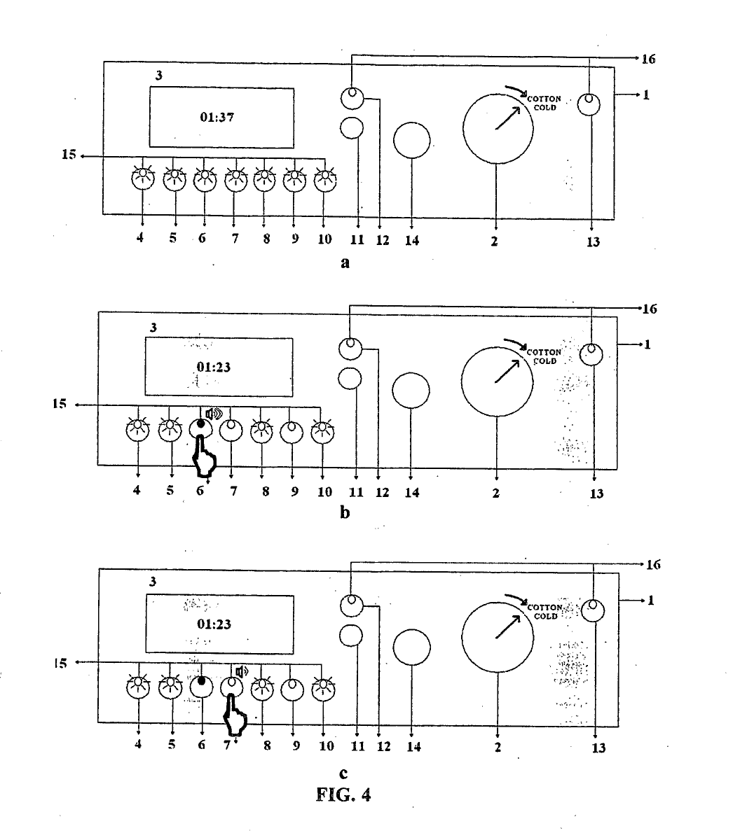

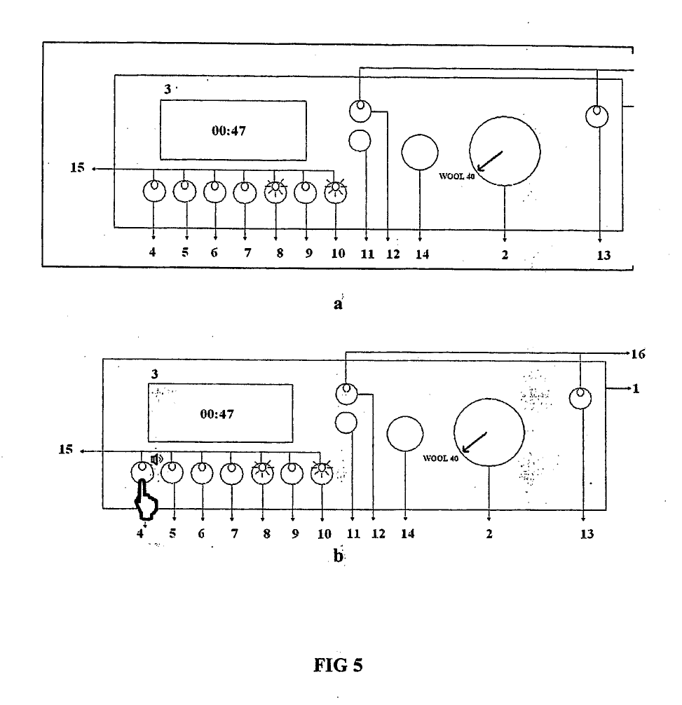

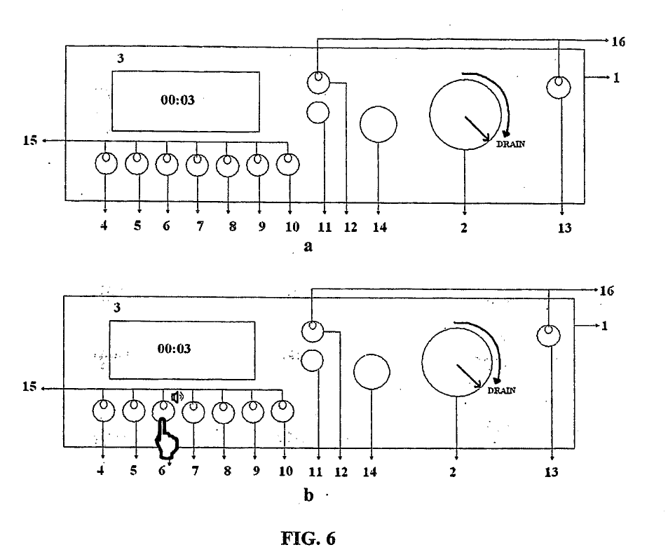

The method for providing a barrier-free appliance is now described by referring to a general flow diagram as provided in FIG. 2. The flow diagram as provided in FIG. 2 is a general one, common to any appliance such as a washing machine, dryer or dish washer and the like, which is operated in accordance with the method of the present invention.

However, as an exemplary embodiment, the implementation of the method of the present invention is described by selecting a washing machine as the appliance. However, this should not be considered as limiting the scope of the present invention, since the method as described in the present invention can equally be made applicable to other implementations like laundry dryer and dishwasher etc.

The barrier-free washing machine is actuated by powering on the washing machine by means of the program selector 2. Initially the micro-controller 19 and the memory table initializations are reset and all the ports (not shown in the figure) are configured. After resetting the micro-controller 19 and the memory 20 the hardware is initialized. After initializing the hardware, the position of the program selector 2 is tested to read the selected appliance-operating program.

Subsequently, the user initiates the desired appliance-operating program by using the selector 2. For instance, considering the Washing Machine as an appliance, some of the appliance-operating programs required for washing fabrics such as Cotton/Linen (Cold-95° C.), Synthetics (Cold-60° C.), Delicate (Cold-40° C.), Woolens/Handwashable (Cold-40° C.) and Silk (Cold-40° C.) are made available to the user on the control panel 1.

For every main appliance-operating program, a series of program cycles are made available to the user. These program cycles are repository functional features for performing various washing tasks. In the present invention, where a washing machine is used as the appliance for implementing the method, the available program cycles are displayed through the plurality of program cycle selectors 4-11.

Accordingly, to enable the user to select available program cycles, corresponding selectors 4-11 are utilized in the following manner viz., pre-washing program cycle 4, soaking program cycle 5, quick washing program cycle 6, intensive washing program cycle 7, water plus program cycle 8, additional rinse program cycle 9, rinse-hold program cycle 10 and time delay program cycle 11. The implementation of the selected program cycles comprises in selecting at least one of appliance operating programs and the corresponding program cycles including setting a pre-set timer for the execution of the selected program cycle, determining the number of wash cycles, determining wash duration, determining water level, setting of temperature of water, modifying drum movement, setting of rinse cycles, and setting of spin sequence.

In another aspect of the present invention, when the appliance is a dish washer as the program-controlled appliance the corresponding changes that are required in the selection of appliance operating program is achieved by implementing at least one of setting a pre-set timer for the execution of the selected program wash cycle, determining number of wash cycles, determining wash duration and water level, setting of temperature of water, modifying the circulation of washing liquid, determining number of rinse cycles, and determining drying sequence.

In another aspect of the present invention, when the appliance is a laundry dryer as the program-controlled appliance the corresponding changes that are required in the selection of appliance operating program is achieved by implementing at least one of setting a pre-set timer for the execution of the selected drying program cycle, determining drying sequence and duration of drying, modifying the temperature of circulated air, regulating the drum movement, cooling of internal temperature, and performing anti-creasing.

On reading the program selector 2 and identifying the corresponding executable appliance-operating program, program timing that is required for the wash of the selected fabric(s) is initialized and displayed on the LCD 3. Thereafter, the relevant program cycles applicable along with the selected appliance-operating program are activated. On activation of the relevant appliance-operating programs, the machine switches over to the user mode of operation.

### User Mode

In the user mode of operation, initially the position of the program selector 2 is read. Thereafter, the available program cycles, which are stored in the memory 20 are retrieved and displayed to the user.

An arrangement of the available and non-available program cycles, which is stored in the memory 20 is depicted in a Table 1.

TABLE 1

| | Appliance | | | | | | | | | |
|---|---|---|---|---|---|---|---|---|---|---|
| | Operating | Program Cycle modules | | | | | | | | |
| | Program | Pre | | Quick | Intensive | Water | Addl. | Rinse | Time | Speed |
| S. No | module | wash | Soak | wash | wash | plus | rinse | hold | Delay | selector |
| 1 | Cotton | ✓ | ✓ | ✓ | ✓ | ✓ | ✓ | ✓ | ✓ | ✓ |
| | Cold | | | | | | | | | |
| 2 | Cotton | ✓ | ✓ | ✓ | ✓ | ✓ | ✓ | ✓ | ✓ | ✓ |
| | 45° | | | | | | | | | |
| 3 | Cotton | ✓ | ✓ | ✓ | ✓ | ✓ | ✓ | ✓ | ✓ | ✓ |
| | 60° | | | | | | | | | |
| 4 | Cotton | ✓ | ✓ | ✓ | X | ✓ | ✓ | ✓ | ✓ | ✓ |
| | 95° | | | | | | | | | |
| 5 | Eco 60° | ✓ | ✓ | ✓ | X | ✓ | ✓ | ✓ | ✓ | ✓ |
| 6 | Synthetic | ✓ | ✓ | ✓ | ✓ | ✓ | ✓ | ✓ | ✓ | ✓ |
| | Cold | | | | | | | | | |
| 7 | Synthetic | ✓ | ✓ | ✓ | ✓ | ✓ | ✓ | ✓ | ✓ | ✓ |
| | 45° | | | | | | | | | |
| 8 | Synthetic | ✓ | ✓ | ✓ | ✓ | ✓ | ✓ | ✓ | ✓ | ✓ |
| | 60° | | | | | | | | | |
| 9 | Delicates | X | X | X | X | X | ✓ | ✓ | ✓ | ✓ |
| | 40° | | | | | | | | | |
| 10 | Silk Cold | X | X | X | X | X | X | ✓ | ✓ | ✓ |
| 11 | Woolen | X | X | X | X | X | ✓ | ✓ | ✓ | ✓ |
| | 40° | | | | | | | | | |
| 12 | Mini 30° | X | X | X | X | ✓ | X | ✓ | ✓ | ✓ |
| 13 | Rinse + | X | X | X | X | ✓ | X | X | ✓ | ✓ |
| | Spin | | | | | | | | | |
| 14 | Spin | X | X | X | X | X | X | X | ✓ | ✓ |
| 15 | Drain | X | X | X | X | X | X | X | ✓ | X |

Note:
✓ - Program Cycle module is available
X - Program Cycle module is non-available

By referring to the above Table 1, for instance, if the user selects “Quick wash” program cycle for the appliance-operating program such as Cotton & Synthetic fabrics, then the program cycles ‘Intensive Wash’ & ‘Additional Rinse’ will be automatically disabled.

On selection of the desired program cycles as made available to the user as per Table 1, the time periods for the completion of the respective program cycle are automatically provided to the appliance-operating program from the memory 20. The approximate time periods and the corresponding program cycles are provided in Table 2

TABLE 2

| | Appliance | | | | | | | | | |
|---|---|---|---|---|---|---|---|---|---|---|
| | Operating | Program Cycle modules | | | | | | | | |
| | Program | Pre | | Quick | Intensive | Water | Addl. | Rinse | Time | Speed |
| S. No | module | wash | Soak | wash | wash | plus | rinse | hold | Delay | selector |
| 1 | Cotton | ✓ | ✓ | ✓ | ✓ | ✓ | ✓ | ✓ | ✓ | ✓ |
| | Cold | | | | | | | | | |
| | Default | | | | | | | | | |
| | timing | | | | | | | | | |
| | 01:37 | | | | | | | | | |
| | (1 h 37 | | | | | | | | | |
| | min) | | | | | | | | | |

Pre wash Default timing increases by 17 minutes 01:54
Soak Default timing increases by 12 minutes 01:49
Quick wash Default timing decreases by 34 minutes 01:03
Intensive wash No changes in default timing 01:37
Water plus No changes in default timing 01:37
Additional rinse Default timing increases by 12 minutes 01:49
Rinse hold No changes in default timing 01:37
Time delay Start of program can be delayed from 30 min to 24 hours 01:37 + Time delay
Speed selector No changes in default timing 01:37

When an appliance-operating program for Cotton is chosen at a cold temperature, considering the default internal setting of the time for the execution of this wash is 01 hour and 37 minutes, it can be seen from the above Table 2 that the time periods for various program cycles are varied automatically in an optimized manner either by increasing the time period of the program cycle or by decreasing the same.

Further, in another aspect of the present invention, when the user selects a set of program cycles corresponding appliance-operating program, the non-compatible program cycles of the selected program cycle will be automatically disabled. For instance, if the user selects quick wash program cycle the corresponding non-compatible program cycles such as intensive wash and additional rinse are disabled as shown in Table 3.

TABLE 3

| | Appliance | | | | | | | | | |
|---|---|---|---|---|---|---|---|---|---|---|
| | Operating | Program Cycle modules | | | | | | | | |
| | Program | Pre | | Quick | Intensive | Water | Addl. | Rinse | Time | Speed |
| S. No | module | wash | Soak | wash | wash | plus | rinse | hold | Delay | selector |
| 1 | Cotton | — | — | ✓ | X | — | X | — | — | — |
| | Cold | | | | | | | | | |

Note:
✓ - Selected PC module
— - Non-selected PC module
X - Automatically disabled PC module

### User Intervention Mode

The actuation of the selected functions is performed in conjunction with a visual display of the same along with an indication for a pre-determined time period for the selected program cycle functions. On completion of the selected program cycle functions, the machine terminates the wash program along with an indication to the user. At any time during the execution or after execution, in case the user wishes to pause the machine, then the user selects the start/pause switch 12.

Further, in another aspect of the present invention, the user is prevented from re-activating the program cycles that have already been executed. For example, if pre-wash program cycle is executed by the machine and during the subsequent rinse program cycle, when the user tries to select the already executed pre-wash program cycle, the execution of pre-wash cycle gets automatically disabled.

In other aspect of the present invention the method wherein, a pre-determined set of sequence of operations is executed. For instance, if the user fails to choose the pre-wash program in the beginning and the same program is not made available to the user during rinse program cycle.

In yet another aspect of the present invention the method wherein, while executing a pre-determined sequence of program cycle operations, the micro controller is disposed to prevent the user from disabling the running program cycle sequence. For instance, if the appliance is in the mode of executing the additional rinse program cycle, the microcontroller prevents any attempt to disable this active rinse program cycle.

We claim:

1. A method for barrier-free control of an appliance, said method comprising,
(a) providing a program-controlled appliance with a control panel having a plurality of operating program selectors for selecting programs of appliance operations and corresponding program cycles, the appliance operating programs executable by a micro controller, the appliance having a memory component for storing the functions of the appliance operating programs and corresponding program cycles, the appliance having a display unit for displaying the output of the status of the appliance operation,
(b) selecting the desired appliance operating program,
(c) enabling by an automatic selection a set of compatible program cycles corresponding to the selected appliance operating program,
(d) disabling automatically the corresponding non-compatible program cycles that are contrary to the selected appliance operating program,
(e) disabling automatically the corresponding non-compatible program cycles that are contrary to the selected program cycles, and
(f) executing the program cycles of the selected appliance operating program.

2. The method according to claim 1, wherein the enablement and disablement of appliance operations are indicated to user by visual and/or audio means.

3. The method according to claim 1, wherein the executing the selected program cycle further comprising; interrupting any running program cycle and resuming the subsequent unfinished pre-selected program cycle.

4. The method according to claim 1, which comprises: providing a laundry washing machine as the program-controlled appliance; and changing the selection of appliance operating program to implement at least one of the program cycles.

5. The method according to claim 4, wherein the implementing at least one of the selected program cycles comprises:
(a) setting a pre-set timer for the execution of the selected program wash cycle,
(b) determining the number of wash cycles,
(c) determining wash duration,
(d) determining water level,
(e) setting of temperature of water,
(f) modifying drum movement,
(g) setting of rinse cycles, and
(h) setting of spin sequence.

6. The method according to claim 1, which comprises: providing a dish washer as the program-controlled appliance; and changing the selection of appliance operating program to implement at least one of the program cycles.

7. The method according to claim 6, wherein the implementing at least one of the selected program cycles comprises:
(a) setting a pre-set timer for the execution of the selected program wash cycle,
(b) determining number of wash cycles,
(c) determining wash duration and water level,
(d) setting of temperature of water,
(e) modifying the circulation of washing liquid,
(f) determining number of rinse cycles, and
(g) determining drying sequence.

8. The method according to claim 1, which comprises: providing a laundry dryer as the program-controlled appliance; and changing the selection of appliance operating program to implement at least one of the program cycles.

9. The method according to claim 8, wherein the implementing at least one of the selected program cycles comprises:
(a) setting a pre-set timer for the execution of the selected drying program cycle,
(b) determining drying sequence and duration of drying,
(c) modifying the temperature of circulated air,
(d) regulating the drum movement,
(e) cooling of internal temperature, and
(f) performing anti-creasing.
